(19) United States
(12) Patent Application Publication
(10) Pub. No.: US 2005/0233073 A1
(43) Pub. Date: Oct. 20, 2005

(54) Method and apparatus for applying coatings, for instance for sanitary products

(75) Inventor: Nicola D'Alesio, Canosa Sannita-Chieti (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/827,193

(22) Filed: Apr. 19, 2004

(51) Int. Cl. B05D 3/12

(52) U.S. Cl. 427/207.1; 427/358

(57) ABSTRACT

A process for applying a coating (M) of a material onto a web (W) includes the step of providing a source (6) of the material to be coated in the fluid state. The source includes one or more output nozzles (11) for emitting the coating material in the fluid state in a first direction (X1). A drive unit produces a relative movement of the output nozzle (11) with respect to the web (W), such a movement taking place in a second direction (X2). The first (X1) and second (X2) directions form an angle (α) therebetween of less than 45°, and preferably about 5°. The web is preferably kept flat and extending in the second direction (X2) at the region where the coating material (M) is applied onto the web (W) and the output nozzle (11) is positioned with respect to the web (W) in such a way that, in travelling from the nozzle (11) to the surface of the web W being coated, the coating material (M) follows a free path over a given distance (d).

### FIELD OF THE INVENTION

The present invention relates to coating technology and was developed by paying specific attention to the possible use in applying coatings onto sanitary products and the like. Reference to the above possible application must not, however, be understood as in any way limiting the scope of the invention, which is of an altogether general nature.

### DESCRIPTION OF THE RELATED ART

International patent application WO-A-99/64505 discloses the utilisation of a low viscosity thermoplastic composition for making liquid impermeable structures, such as films or layers, with enhanced moisture vapour permeability in absorbent articles. Exemplary of such absorbent articles are diapers, sanitary napkins, panty liners and incontinence products, and also protective bedding covers, protective clothing and the like.

A wide variety of processes for applying onto a web or substrate a coating of a material, such as the low viscosity thermoplastic composition cited above, are known in the art. A number of these involve the use of a source of the material intended to form the coating, such a source including a nozzle or slit for matting that material in the fluid state. Such a material in the fluid state is applied onto a web while the web performs a relative movement with respect to the output nozzle, so that a substantially uniform coating is formed onto the web or substrate.

Examples of such arrangement are shown, for instance, in JP 5050002 or U.S. Pat. No. 5,458,913 or U.S. Pat. No. 4,343,259. In the arrangement disclosed in the last-cited document, the output nozzle for the coating material is comprised of a slit or series of orifices having associated a thin, flexible downstream spreader element.

Other arrangements of substantially the same type are disclosed, for instance, in U.S. Pat. No. 4,299,186, U.S. Pat. No. 4,386,998, U.S. Pat. No. 4,480,583, U.S. Pat. No. 5,042,422, U.S. Pat. No. 5,108,795, U.S. Pat. No. 5,302,206, U.S. Pat. No. 5,418,004, U.S. Pat. No. 6,033,723, EP-A-0 566 124, EP-A-0 661 102, JP 2227159, JP 2265672, JP 3296467, and JP 7185437.

The arrangements disclosed in the documents referred to in the foregoing provide for the material in the fluid state, intended to form the coating, to exit an output nozzle, from which it is ejected or extruded. In most arrangements, the material exits the nozzle in a direction that is approximately perpendicular or orthogonal (that is forming an angle of approximately 90°) with respect to the direction of the relative movement of the web. Also, in most of these prior art arrangements, in the region where the coating material is applied, the web is caused to travel an arcuate path defining a concave trajectory having a concavity facing the source of the coating material, that is the output nozzle.

Substantially similar arrangements are disclosed, also JP 5293418, JP 11314065 and JP 11267570. These last-cited documents disclose arrangements wherein a single applicator head for the coating includes two output nozzles arranged in a staggered or cascaded fashion with respect to the direction of relative movement of the applicator head with respect to the web, in order to possibly permit application of two separate coatings (such as a pre-coating layer and a proper coating layer) in a single pass.

In EP-A-0 064 340 a glue application system is disclosed including a flexible tapered nozzle having a tubular body and a tip. The tip has an end, which contacts a supported surface of a selected web at an angle orthogonal to the supported surface. In the region where the tip contacts the web, the web itself follows an arcuate path with a convexity facing the nozzle as a result of the web movement being guided around a roller.

In known “contact” processes, the coating material in the fluid state (typically a molten thermoplastic composition or the like) is extruded directly against the web or substrate being coated and is actually pressed onto it by the nozzle acting as an extrusion head. In most arrangements, extrusion actually occurs at an almost normal or orthogonal angle with respect to the web or substrate. The disadvantage, typically with fibrous materials (such as non-woven layers or webs) is that the coating material tends to impregnate the substrate or web in depth.

Low viscosity, hot melt compositions used as coating material are particularly prone to exhibit such behaviour.

Under these circumstances, low thickness coatings are difficult to achieve. This especially applies to continuous coatings that are important where a breathable film is used which must also form a liquid impervious barrier. Also, hot melt layers may be easily perforated by any fibres possibly protruding from the substrate or web, thus further impairing the continuity being sorted.

While most of the prior art arrangements considered in the foregoing provide for “contact” coating, that is causing the output nozzle to contact the web being coated, alternative arrangements exist wherein a non-contact coating arrangement is resorted to for producing a continuous coating. Exemplary for these arrangements is the arrangement disclosed in WO-A-96/25902, which however results in a fairly complex and critical apparatus and machinery.

### OBJECT AND SUMMARY OF THE INVENTION

The object of the present invention is thus to provide an improved solution adapted to overcome the intrinsic drawbacks of the prior art arrangements considered in the foregoing.

According to the present invention, such an object is achieved by means of a process having the features set forth in the claims that follow. The invention also relates to apparatus for carrying out the process of the invention.

Essentially, the invention aims at minimising the component of the direction of application of the coating material that is perpendicular (normal) to the web or substrate being coated.

If this “vertical” component is high (this being the case in point when the coating material is actually applied vertically with respect to the substrate, as is known in the art) a pressure problem arises created by the accumulation of the coating material (e.g. hot melt material), which is directed against the substrate.

This prevents the hot melt material from leaving the nozzle(s) smoothly and regularly, and gives rise to a less regular coating layer, that is a layer failing to exhibit a desired constant thickness.

The invention provides a better homogeneity of the coating layer, namely a constant thickness, such a thickness being also more easily controlled and regulated in the absence of any antagonist effect of the substrate.

These advantages are achieved with any type of coating material such as a hot melt material.

The main advantage related to the use of hot melt material is that the coating is prevented from penetrating into the substrate, which is typically a non-woven substrate material, but could also be in the form of foam.

Another parameter which influences thickness control in the coating layer is the flow rate of the hot melt material with respect to the substrate speed.

In conventional slot coating apparatus, it is difficult to control precisely the flow rate, and hence the thickness, of the coating material, especially when very thin layers are desired.

The arrangement of the invention enables such a control to be carried out quite effectively, thus making it possible to deposit on the substrate a continuous layer having a constant thickness (also a very low thickness).

### BRIEF DESCRIPTION OF THE DRAWINGS

The invention will now be described, by way of non-limiting example only, with reference to the annexed figures of drawing, wherein:

FIG. 1 schematically represents coating apparatus for possible use within the framework of the invention,

FIG. 2 is an enlarged side elevational view of a coating device according to the invention, and

FIG. 3 is a further enlarged view of the portion of FIG. 3 identified by arrow III, better highlighting the geometry of the coating apparatus of the invention.

### DETAILED DESCRIPTION OF EXEMPLARY EMBODIMENTS OF THE INVENTION

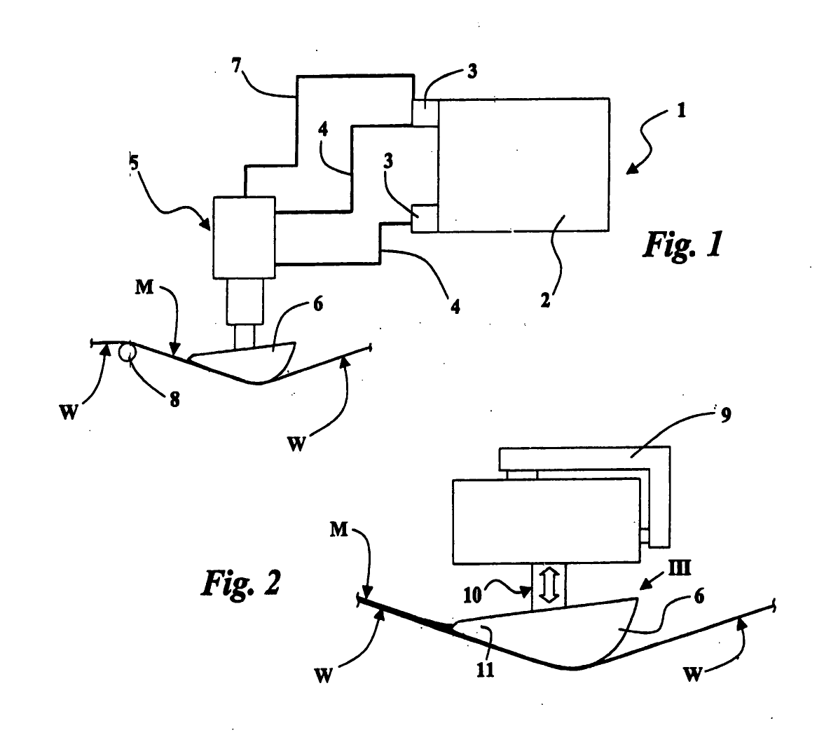

FIG. 1 shows the basic layout of coating apparatus 1 adapted for applying onto a moving web W a layer M of a coating material.

An arrangement as shown in FIG. 1 may be applied, for instance, to the manufacture of liquid impermeable, moisture vapour permeable layers obtained by coating a thermoplastic composition onto a substrate. A suitable thermoplastic composition may comprise thermoplastic polymers and suitable hydrophilic plasticisers that may also enhance the moisture vapour permeability of films or layers made from the thermoplastic compositions. Such layers can find a variety of applications wherein moisture vapour permeability is desirable, such as within absorbent articles such as diapers, sanitary napkins, panty liners and the incontinence products, and also protective bedding covers, protective clothing and the like. The substrate being coated may be any kind of laminar substrate such as, for instance, a non-woven web of the kind commonly used in the manufacture of the sanitary articles referred to in the foregoing.

A number of thermoplastic compositions particularly adapted for use in such a coating process are disclosed, for instance, in WO-A-99/64077, WO-A-99/64505, WO-A-01/97870, WO-A-01/98399, WO-A-02/14417, WO-A-02/28951.

In any case the scope and the spirit of the present invention is in no way limited to such a prospected application.

In general terms, the coating material may be advantageously selected from the group consisting of hot melt adhesives, while the web being coated is selected from the group consisting of nonwowen materials, polymer films, and siliconised foil materials (paper/films).

Advantageously, the material of said web W is selected from the group consisting of polyethylene (PE) and polypropylene (PP).

The coating material M is applied onto the web W in the fluid (that is, molten) state. For that purpose, apparatus 1 generally includes a tank or reservoir 2 for containing the coating material in the fluid state. One or more pumps 3 are provided for pumping the coating material M from the reservoir 2 by means of sleeves or hoses 4 towards an applicator unit 5 including an applicator head (or “gun”) 6.

A return line or hose 7 is provided for re-circulating coating material not applied onto the web W back towards one of the pumps 3 and/or the reservoir 2.

The coating material M is delivered from the applicator head or gun 6 through one or more output nozzles 11, so as to be deposited onto the web W in the form of a substantially continuous layer or line as a result of the relative movement of the web W being caused to advance under the applicator head 6 (from right to left in FIGS. 1 to 3).

To that end the web W is usually driven by means of a capstan roller 8 or the like driven by a motor (not shown) and thus caused to slide under the applicator head 6.

In order to maintain the coating material M in the molten state, heating elements (of a known type, not shown) are associated with the tank 2, the pumps 3, the delivery and return lines 4 and 7, as well as the applicator unit 5 and, more specifically, the applicator head 6.

The arrangement considered in the foregoing is per se thoroughly conventional in the art and does not require to be described in greater detail herein.

FIG. 2 is an enlarged side elevational view of the applicator unit 5 that is usually mounted onto a supporting element such as a bracket 9 included in the supporting framework (not shown) of coating apparatus 1 in the vicinity of the drive roller 8.

In the presently preferred embodiment of the invention, the applicator head 6 is located generally in the lower portion of the applicator unit 5. The web to be coated W is thus caused to advance under the applicator unit 5 in sliding contact with the lower surface of the applicator head 6. The applicator head 6 can be mounted on the applicator unit 5 by means of an arrangement, such as telescopic arrangement 10. The applicator head 6 as a whole is thus capable of moving, at least slightly, in the vertical direction (as shown by the double arrow in FIG. 2) in order to allow for possible variations of the degree of longitudinal tension applied to the web W. Alternatively, the whole applicator unit 5 can be capable of making said vertical movement.

The applicator head 6 is usually in the form of a box or similar casing preferably having a generally tapered profile that, in the presently preferred embodiment of the invention, is in the form of a droplet-type or raindrop-type profile.

Essentially, the applicator head 6 is comprised of at least a partially hollow body having flow lines for the coating material M extending therethrough and leading to one or more outlet nozzles 11 generally located at the downstream end of the applicator head 6. The nozzle or nozzles 11 can be in the form of e.g. slits or holes thus enabling the coating material M expelled (extruded) therefrom to be in the form of a flat layer or lines.

As used herein, the “downstream” end of the (lower) surface of applicator head 6 is intended to mean that end of the applicator head 6 that is located downstream of the applicator head 6 itself with respect the relative movement of the web W to be coated, i.e. where the output nozzle or nozzles 11 are located.

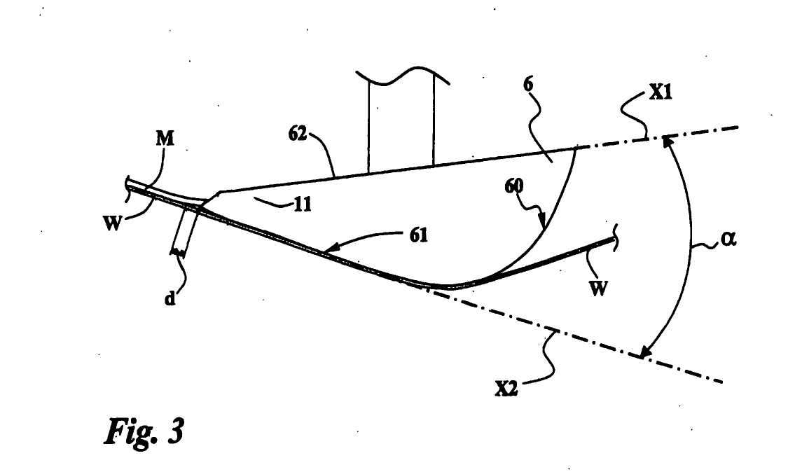

The relative movement of the web W with respect to the applicator head 6 is arranged to take place in a application or coating region where the coating material M is actually applied onto the web W by means of the nozzle or nozzles 11, while the web is kept in caused to follow a rectilinear path, that is a path lying in a plane designated X2 (see FIG. 3).

The cross-sectional view of applicator head 6 is thus comprised of an “upstream” end 60 of a generally rounded shape at which the web W to be coated contacts the applicator head 6. Such generally rounded shape enables the web W to be, at least slightly, wrapped around the upstream end 60 of the applicator head 6 to follow an at least marginally curved (i.e. concave) trajectory while sliding against the applicator head 6.

A substantially flat intermediate portion 61 is provided in the outer surface of the applicator head 6 such intermediate portion extending from the upstream end 60 of the applicator head 6 towards the downstream end where the nozzles 11 are located. Such an intermediate portion 61 of the surface of the applicator head 6 being flat allows the web W to follow a substantially rectilinear trajectory, thereby taking on a generally flat shape in plane X2, while being advanced towards and through the application or coating region where the coating material M is ejected from the nozzle or nozzles 11.

As better appreciated in the enlarged view of FIG. 3, the flat intermediate surface 61 of the applicator head 6 and the web W are generally intended to be substantially co-planar during the coating process.

While preserving such substantial co-planarity, the applicator head 6 is preferably arranged with respect to the plane X2 in order to ensure that the nozzles 11, from which the coating material M is extruded, do not exactly lie against the surface of the web W.

Preferably, the relative orientation of the web W and the applicator head 6 (i.e. the nozzle or nozzles 11) is selected in such a way that in travelling from the nozzle or nozzles 11 to the surface the web W being coated, the coating material M follows a “free” path having over a distance d. Typical values for d are in the range of 0 to 0.5 mm, preferably between 0 and 0.25 mm, and, in any case, less than 0.5 mm. The relative size of distance d in FIG. 3 has been evidently exaggerated for the sake of illustration.

The coating material M is ejected from the nozzles 11 in a given direction X1 that, in the exemplary embodiment shown in FIGS. 2 and 3, roughly corresponds to the plane of the upper, generally flat surface 62 of applicator head 6.

The general orientation of the direction X1 with the respect to the body of the applicator head 6 can in any case be selectively varied by correspondingly modifying the structure of the applicator head 6; such variations are within the ability of those of skill in the art and, as such, do not require to be described in detail here.

An important feature of the arrangement of the invention lies in the relative orientation of the direction or plane X1 where the coating material M is ejected (extruded) from the nozzle or the nozzles 11 and the plane X2 where the portion of the web W being coated extends.

Experiments carried out by the Applicants indicate that the angle α formed between the direction X1 and the direction X2 may be preferably less than 45°, preferably less than 30°, still preferably less than 20°, the presently preferred value being less than 10°.

Again, the relative size of angle α in FIG. 3 has been evidently exaggerated for the sake of illustration.

In connection with the coating of a substrate or web such as non-woven materials for use in sanitary products coated with thermoplastic compositions, preferred ranges for the angle α are between 0° and 30°, preferably between 0° and 20°, still preferably between 0° and 10′, the presently preferred value being about 5°.

Of course, the quantitative data provided in the foregoing are to be construed by taking into account the tolerances currently involved both in the implementation and in the measurement of the respective values.

Experiments carried out by the Applicants indicate that by resorting to such an arrangement, all the basic drawbacks of known processes wherein a molten composition is extruded directly against a substrate being coated and actually pressed onto it by the extrusion head are securely dispensed with. More to the point, especially in the presence of low viscosity hot melt compositions, the arrangement shown herein safely avoids any impregnation in depth of the substrate being coated by the coating material.

With the arrangement shown herein, low thickness coatings can be easily achieved, this applying particularly to continuous coatings, that are important when breathable compositions are used and are also intended to provide a liquid impervious barrier. Also, perforations usually generated by the fibres comprised in a non-woven substrate in the known “contact” coating methods, do not take place when e.g. hot melt layers are applied onto such a substrate by means of the coating process disclosed herein. This results in improved layer or film formation, particularly in terms of low thickness and uniformity/continuity of the coating.

Moreover, the specific geometry of the applicator head 6 shown in the drawings, leads the applicator head 6 to act as a sliding shoe capable of exerting a pressure against the substrate W before contact with the coating material (typically a hot melt composition) occurs. This gives rise to a sort of “ironing” action exerted by the sliding shoe comprised in the applicator head that stabilises the web before coating, also due to the relatively high temperature of the applicator head itself.

Even without wishing to be bound to any specific theory in that respect, Applicants have reason to believe that the unexpected results achieved by the arrangement of the present invention are primarily related to the essentially “tangential” arrangement of the nozzle or nozzles 11 with respect to the plane where the web W to be coated lies (i.e. direction X1 lying within a small angular range with respect to the plane X2). Also, the coating material M coming out of the nozzle or nozzles 11 and deposited on the surface of the web W in an essentially unconstricted or unconfined manner (“free” path over the distance d in FIG. 3) is held to help in achieving particularly satisfactory results. By unconstricted or unconfined manner a situation is intended where the coating layer formed of material M is in no way urged or forced against the web W being coated as a result of being extruded from the nozzle or nozzles 11 having a distance d with respect to the surface of the web W to be coated. While avoiding the drawbacks of the prior art arrangements, the solution shown herein does in no way adversely affect the desired adhesion of the coating layer to the web W being coated.

Especially for non-woven substrates, the combination and the hold-down strength in the adhesion of the coating layer to the substrate being coated may be possibly reinforced by resorting to a conveyor with vacuum, thus achieving very smooth and delicate way of operation without having to use e.g. rollers and the like.

The arrangement shown in the drawings is particularly adapted for producing materials of the type disclosed in WO-A-99/64505 at a low basis weight (12.5-16 grams per square meter), operating e.g. with a 200 millimetres coating width. Typical fluid pressure within the applicator head or gun 6 is between 30 and 40 bar, with maximum pressure values around 70 bars, the temperature of coating material at the application point being around 200° C.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for applying a coating of a material onto a web, said process comprising the steps of
a. providing a source of said material in the fluid state, wherein said source comprises at least one output nozzle for emitting said material in the fluid state in a first direction;
b. producing a relative movement between said at least one output nozzle and said web by keeping said at least one output nozzle at least in the vicinity of said web at a coating region, whereby said coating material in the fluid state emitted from said at least one output nozzle is applied onto said web at said coating region, wherein said relative movement takes place in a second direction, said first and second directions forming an angle therebetween, wherein said angle is less than 45°.

2. The process of claim 1, further comprising the step of maintaining said web essentially flat and extending in said second direction at said coating region.

3. The process of claim 1, further comprising the step of mutually positioning said at least one nozzle with respect to said web at said coating region in such a way that in travelling from said at least one nozzle to the surface of the web being coated, the coating material follows a free path over a given distance.

4. The process of claim 1, wherein said angle is less than 30°.

5. The process of claim 1, wherein said angle is about 5°.

6. The process of claim 3, wherein said distance is between 0 and 0.5 mm.

7. The process of claim 1, wherein said coating material comprises a hot melt adhesive.

8. The process of claim 1, wherein web is selected from the group consisting of nonwowen materials, polymer films, siliconised foil materials and combinations thereof.

9. The process of claim 1, wherein the material of said web is selected from the group consisting of polyethylene, polypropilene and combinations thereof.

10. An apparatus for applying a coating of a material onto a web, said apparatus comprising:
a. an applicator head for applying said material in the fluid state, said applicator head comprising at least one output nozzle for emitting said material in the fluid state in a first direction;
b. a drive unit for producing a relative movement between said at least one output nozzle and said web by keeping said at least one output nozzle at least in the vicinity of said web at a coating region, wherein said relative movement takes place in a second direction, said first and second directions forming an angle therebetween, wherein said applicator head is arranged such that said angle is less than 45°.

11. The apparatus of claim 10, wherein said drive unit is arranged to maintain said web essentially flat and extending in said second direction at said coating region.

12. The apparatus of claim 10, wherein said at least one nozzle is positioned with respect to said web at said coating region in such a way that, in travelling from said at least one nozzle to the surface of the web being coated, the coating material follows a free path over a given distance.

13. The apparatus of claim 10 wherein said angle is less than 30°.

14. The apparatus of claim 10, wherein said angle about 5°.

15. The apparatus of claim 12, wherein said distance is between 0 and 0.5 mm.

16. The apparatus of claim 10, wherein said applicator head comprises a tapered shape, said tapered shape converging towards an output end of said applicator head, said at least one output nozzle being provided on said output end of said applicator head.

17. The apparatus of claim 16, wherein said applicator head comprises a raindrop-type cross section.

18. The apparatus of claim 10, wherein said applicator head comprises an outer surface adapted for slidingly contacting said web.

19. The apparatus of claim 18, whereby said web slidingly contacting the outer surface of said applicator head is kept essentially flat at said coating region.

20. The apparatus of claim 10, further comprising a support fixture for supporting said applicator head in a generally floating arrangement, whereby said applicator head allows for variations in the tension of said web.
